(19) United States
(12) Patent Application Publication
(10) Pub. No.: US 2010/0046818 A1
(43) Pub. Date: Feb. 25, 2010

(54) IMAGE RECONSTRUCTION METHOD FOR TOMOGRAPHY SCANNER, FAILURE DIAGNOSIS METHOD, TOMOGRAPHY SCANNER AND MANAGEMENT PROGRAM FOR SYSTEM MATRIX

(75) Inventors: Taiga Yamaya, Chiba-shi (JP); Hideo Murayama, Chiba-shi (JP); Eiji Yoshida, Chiba-shi (JP)

Correspondence Address: OLIFF & BERRIDGE, PLC, P.O. BOX 320850, ALEXANDRIA, VA, 22320-4850, US

(73) Assignee: NATIONAL INSTITUTE OF RADIOLOGICAL SCIENCES., Chiba-shi (JP)

(21) Appl. No.: 12/450,349

(22) PCT Filed: Mar. 30, 2007
(86) PCT No.: PCT/JP2007/057229

§ 371 Date: Sep. 22, 2009

(30) Foreign Application Priority Data
Mar. 29, 2007 (JP) 2007-087480

(51) Int. Cl. G06K 9/00; G08B 21/00

(52) U.S. Cl. 382/131; 340/679

(57) ABSTRACT

In a case where an error is included in measurement data corresponding to one or a plurality of detecting elements in a tomography scanner, a system matrix to be calculated or referenced on image reconstruction calculation is corrected in accordance with the error. Thus, even when an error such as a defect or a fault occurs in a detector, influence of the error is eliminated, thereby reducing an artifact generated in an image. At that time, positional information of the detecting elements including the error and information on the degree of the error are stored in a storage device and referenced inside image reconstruction software, thus making it possible to correct the system matrix in accordance with the error.

### TECHNICAL FIELD

The present invention relates to an image reconstruction method for a tomography scanner, a failure diagnosis method, a tomography scanner and a management program for a system matrix preferably used for a tomography scanner such as an X-ray CT scanner, a single photon emission computed tomography (SPECT) scanner, and a positron emission tomography (PET) scanner.

### BACKGROUND ART

The tomography scanner such as the X-ray CT scanner, the SPECT scanner, and the PET scanner is a system in which a physical quantity of an object (an image) serves as an input and measurement data by a (radiation) detector 12 serves as an output as in the example of a PET scanner 10 shown in FIG. 1. In general, when a j^{th} pixel value of the object is fⱼ and a measurement value of an i^{th} detector channel is gᵢ, a system model 14 indicating conversion in the forward projection is defined in the following equation using a system matrix {aᵢⱼ}.

gᵢ=Σaᵢⱼfⱼ (1)

In this drawing, the numeral 16 depicts a subject to-be-examined and the numeral 18 depicts a bed.

Image reconstruction is derived as inverse transformation of the system model 14. Therefore, in order to increase the accuracy of an image, it is important to accurately model a system (refer to “Radiation Technology Series: Nuclear Medicine Technology” ed. by the Japanese Society of Radiological Technology, Ohmsha, Ltd., 1^{st} printing of the 1^{st} edition, pp. 135-143, 30 Apr. 2002).

Meanwhile, as a detector for the PET scanner, Japanese Published Unexamined Patent Application No. 2004-279057 proposes a block detector (also called a DOI detector) 20 capable of obtaining information on depth of interaction (DOI) which is formed by a number of radiation detector elements as shown in FIG. 2. In this drawing, the numerals 21 to 24 depict scintillator arrays on layers and the numeral 26 depicts a photo detection element.

However, when an error such as a defect or a fault occurs in the detector 12, the system model 14 is deviated from actual scanner characteristics as shown in the upper part of FIG. 3. Therefore, there was a problem that an artificial image, that is, an artifact is generated in a reconstructed image, thereby reducing the quality of an image.

In recent years, use of tomography scanner has spread and its role has increasingly become significant in medical practice. Meanwhile, highly-developed scanners require an increasing number of detectors, thereby causing a tendency of increasing risk due to failure and boosting maintenance costs for avoiding such risk. In general, in a case where the problem is caused in the scanner, there is a need to cancel a scheduled check-up and repair the scanner immediately. Particularly, in a case where the failure of the detector is found after the check-up, a recheck-up is sometimes required.

The block detector 20 as shown in FIG. 2 has the capability of a low discrimination performance on a block end as shown in the upper part of FIG. 4, thereby generating the artifact as well.

### DISCLOSURE OF THE INVENTION

The present invention has been made in order to solve the above-described conventional problems, and a first object of the present invention is to eliminate an influence of an error even when an error such as a defect or a fault occurs in a detector, thereby reducing an artifact generated in an image.

A second object of the present invention is to utilize the above-described image reconstruction method, thereby performing failure diagnosis of a tomography scanner.

In the present invention, in a case where an error is included in measurement data relative to one or a plurality of detecting elements in a tomography scanner, a system matrix to be calculated or referenced on image reconstruction calculation is corrected in accordance with the error as shown in the lower part of FIG. 3, thereby reducing an artifact generated in an image, by which the above-described first object is achieved.

Here, positional information of the detecting elements including the error and information on the degree of the error is stored in a storage device and referenced inside image reconstruction software, thus making it possible to correct the system matrix in accordance with the error.

The measurement data corresponding to the detecting elements in which the error occurs may be eliminated before performing the image reconstruction calculation.

In a detector unit, a coincidence count determiner, a data converter or a data addition unit, the measurement data corresponding to the detecting elements in which the error occurs may not be output but eliminated.

In the present invention, in a case where a failure or a trouble occurs at any point in a tomography scanner before or during a check-up, image reconstruction is performed to simulation data or other measurement data by applying the above-described method and quality of an image is confirmed, thereby simulating an influence of an error on the image reconstruction and determining whether the scanner is to be repaired or the check-up is continuable, by which the above-described second object is achieved.

The present invention is to provide a tomography scanner, in which in a case where an error is included in measurement data corresponding to one or a plurality of detecting elements in the tomography scanner, positional information of the detecting elements including the error and information on the degree of the error for correcting a system matrix to be calculated or referenced on image reconstruction calculation in accordance with the error are stored in a storage device.

The present invention is to provide a management program for a system matrix to be calculated or referenced on image reconstruction calculation, in which in a case where an error is included in measurement data corresponding to one or a plurality of detecting elements in a tomography scanner, the system matrix is corrected in accordance with the error while referencing to a storage device storing positional information of the detecting elements including the error and information on the degree of the error, thereby reducing an artifact generated in an image.

According to the present invention, even when an error such as a defect or a fault occurs in the detector, the influence of the error is eliminated, thus making it possible to reduce the artifact generated in an image. Therefore, there is no need for cancelling the check-up and also the scanner is less frequently repaired, thereby producing a large economic effect. Further, even in a case where failure of the detector is found after the check-up, deteriorated quality of an image can be avoided by post processing, and hence there is sometimes a case where the recheck-up may be avoided.

### BRIEF DESCRIPTION OF THE DRAWINGS

FIG. 1 is a conceptual diagram of a system model on image reconstruction in a PET scanner for illustrating a principle of the present invention.

FIG. 2 is a perspective view illustrating a constitution example of a block detector.

FIG. 3 is a conceptual diagram of the present invention in the PET scanner.

FIG. 4 is a diagram for illustrating a property of the block detector and improvement by the present invention.

FIG. 5 is a diagram illustrating a mounting example using an error table according to the present invention.

FIG. 6 is a flow chart similarly illustrating procedures for creating the error table.

FIG. 7 is a diagram illustrating an example of the error table.

FIG. 8 is a diagram illustrating a method for eliminating error data according to the present invention.

FIG. 9 is a diagram illustrating an example of the method for eliminating the error data.

FIG. 10 is a flow chart similarly illustrating procedures for processing.

FIG. 11 is a diagram similarly illustrating an example of a radiation route.

FIG. 12 is a diagram similarly illustrating an example of a position and energy lookup table.

FIG. 13 is a diagram similarly illustrating an example of a coincidence counting lookup table.

FIG. 14 is a diagram illustrating an example of a combination of the radiation route.

FIG. 15 is a diagram illustrating an example of a DOIC lookup table.

FIG. 16 is a diagram illustrating another example of procedures for processing the error data.

FIG. 17 is a flow chart illustrating simulation procedures for predicting the degree of an error.

FIG. 18 is an illustrative view of the simulation.

FIG. 19 is a diagram similarly illustrating an example of a relationship between an error detector and a change in quality of an image.

FIG. 20 is a conceptual diagram of Example 1.

FIG. 21 is a conceptual diagram of Example 2.

FIG. 22 is a diagram illustrating a modified example of the detector.

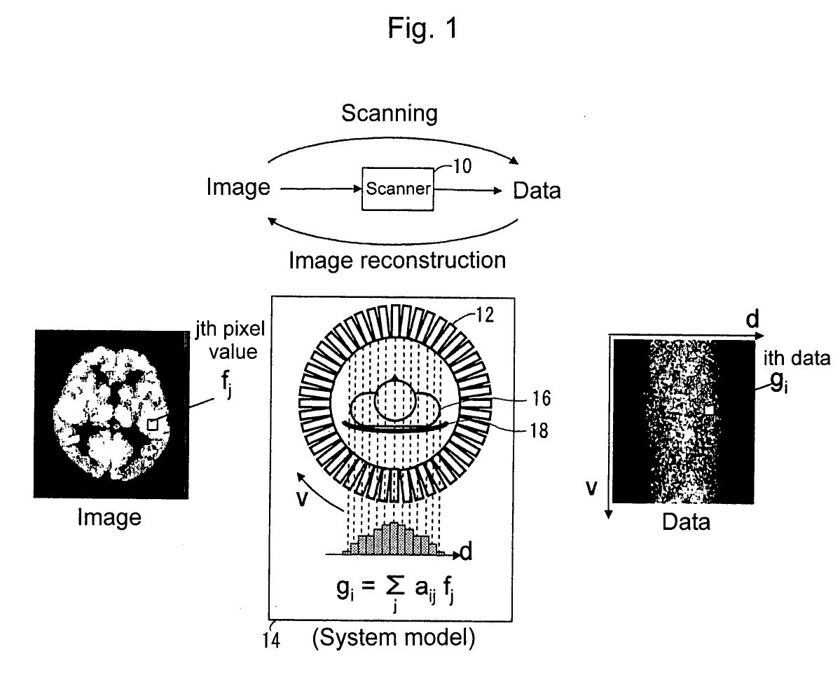

### BEST MODE FOR CARRYING OUT THE INVENTION

Hereinafter, a description will be given in detail for an embodiment of the present invention by referring to the drawings.

It is considered that the quality of an image is largely decreased due to an error of a detector, since a system model defined in image reconstruction does not match with the actual scanner characteristics. Therefore, in the present embodiment, an error detector itself is removed from both data and the system model, thereby eliminating a mismatch of the system model. In this case, since a specific system model cannot be adopted for the filtered back projection (FBP) method generally used in the image reconstruction, an algebraic method or a statistical method such as iterative image reconstruction methods (such as the ML-EM method) is used.

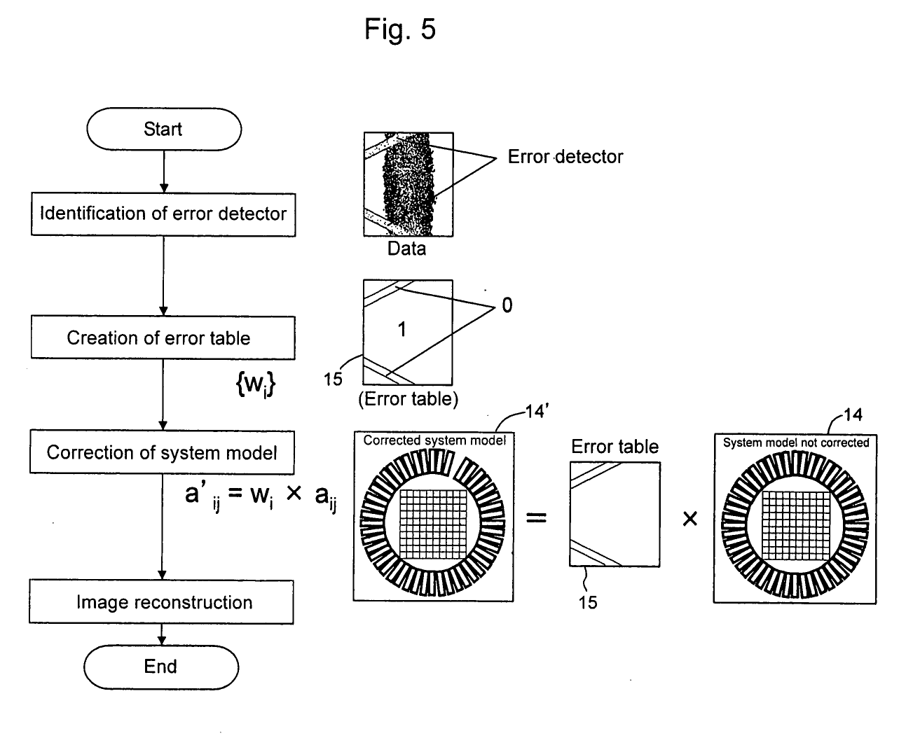

Specifically, as shown in FIG. 5, a matrix element aᵢⱼ of the system model is multiplied by a weight factor wᵢ using an error table 15, thereby replacing aᵢⱼ with wᵢaᵢⱼ. Here, the weight factor wᵢ is zero in the error detector and one in other detectors. In a case where the degree of the error is slight or in a case where the error stochastically occurs in the error detector, the weight factor wᵢ may be a numerical value within a range from zero to one in accordance with the degree of the error or a occurrence probability.

In general, a point where the detector error occurs cannot be predicted. However, the system model can easily be corrected without modifying software or recalculating a system matrix in accordance with the error.

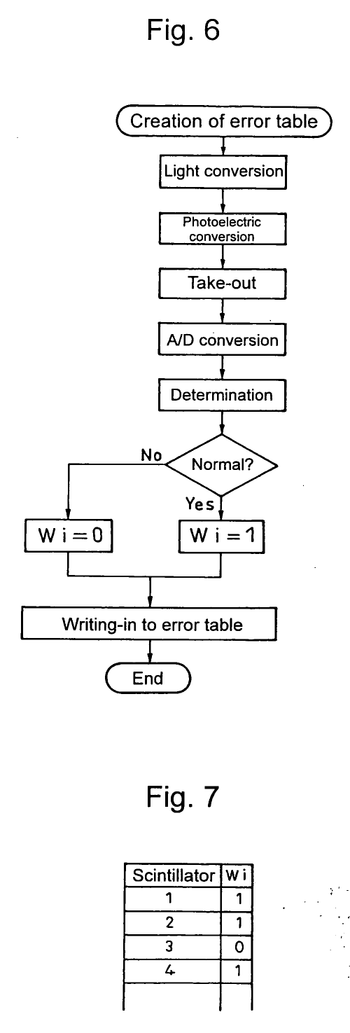

FIG. 6 shows procedures for creating the error table and FIG. 7 shows one example of the created error table.

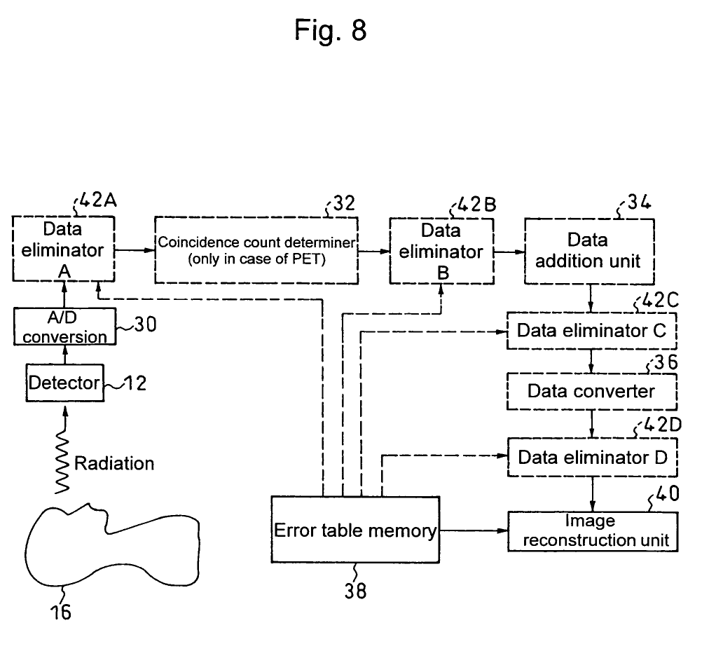

In the present invention, in a case where an element of the error table corresponding to the error detector is set to be zero, existence of data measured by the error detector (hereinafter, referred to as error data) does not influence a reconstructed image at all. However, as shown in FIG. 8, the error data itself is eliminated from data flow from a detector 12 to an image reconstruction unit 40, thereby making the system efficient and highly accurate. In this drawing, the numeral 30 depicts an A/D converter, the numeral 32 depicts a coincidence count determiner (only in a case of PET), the numeral 34 depicts a data addition unit, the numeral 36 depicts a data converter, and the numeral 38 depicts an error table memory.

A radiation in FIG. 8 indicates an X-ray in an X-ray CT scanner, a γ ray in a SPECT scanner, and an annihilation radiation in a PET scanner. When measured by the detector 12, through a positional discrimination circuit or others, the radiation is converted into information on a position and a quantity of the time-integrated radiation or radiation positional information per one count. In the PET scanner, successively through the coincidence count determiner 32, a detector pair with which the annihilation radiation is measured is specified and taken as one count. The subsequent processing method for count data aligned in this time series is considered to include (1) a method for directly performing the image reconstruction; (2) a method for adding the data to histogram data in the data addition unit 34 and then performing the image reconstruction; and (3) a method for converting the data, e.g. converting the data into the histogram data in the data addition unit 34 and further suppressing data redundancy in the data converter 36, and then performing the image reconstruction.

With an example of the PET scanner, the processing in the data converter 36 includes the Fourier Rebinning (FORE) method for compressing three-dimensional mode data into two-dimensional mode data with attention given to the data redundancy in the body axis direction (refer to M. Defrise, P. E. Kinahan, D. W. Townsend, et al., “Exact and approximate rebinning algorithms for 3-D PET data,” IEEE Trans. Med. Imag., vol. 16, pp. 145-158, 1997), and the DOI compression (DOIC) method for compressing PET data including information on depth of interaction (DOI) in data size while suppressing the data redundancy in the DOI direction (refer to T. Yamaya, N. Hagiwara, T. Obi, et al., “DOI-PET Image Reconstruction with Accurate System Modeling that Reduces Redundancy of the Imaging System,” IEEE Transactions on Nuclear Science, Vol. 50, No. 5, pp. 1404-1409, 2003).

In the data converter 36, with any method, there is a possibility that normal data and error data are mixed in a process of conversion, thereby diffusing the error data.

Data elimination according to the present invention is to eliminate the data regarding the preliminarily specified error detector by referring to the error table or others. It is possible to mount a data eliminator 42 in any of four points 42A to 42D in FIG. 8.

In a case where the data is eliminated at the point 42D, the data quantity to be processed in the image reconstruction unit 40 is reduced in accordance with the quantity of the eliminated error data, thereby causing an effect of accelerating image reconstruction calculation. However, it is not possible to avoid mixing between normal data and error data in the data converter 36.

In a case where the data is eliminated at the point 42C, it is possible to avoid mixing between normal data and error data in the data converter 36. Therefore, it is possible to accelerate the image reconstruction calculation and also increase accuracy of the error exclusion.

When the data is eliminated at the point 42B or further the point 42A which is the upper stream, it is possible to reduce the data quantity itself flowing through the system in addition to the above-described effects. Therefore, it is possible to expand the dynamic range of the scanner.

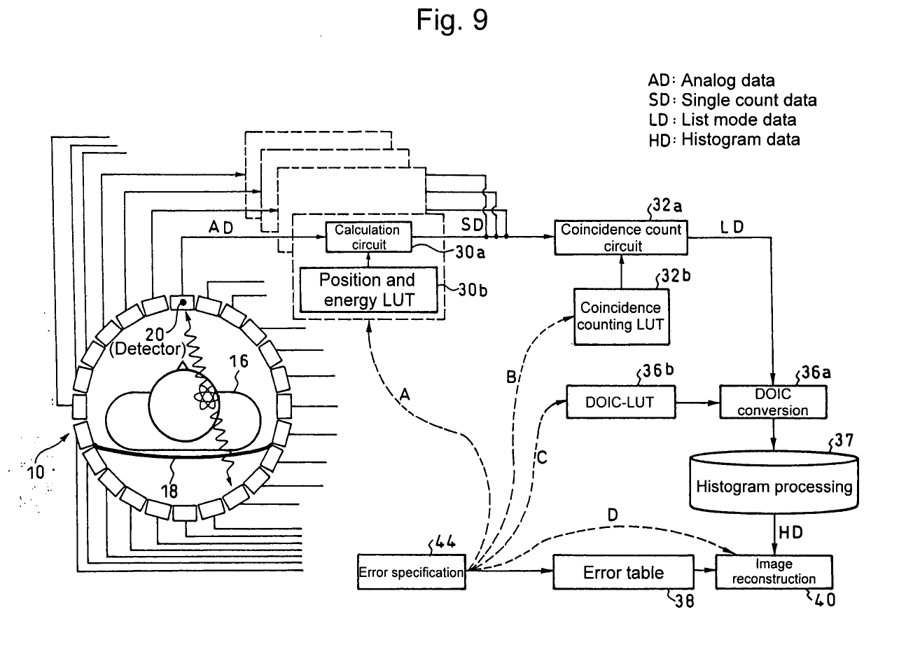

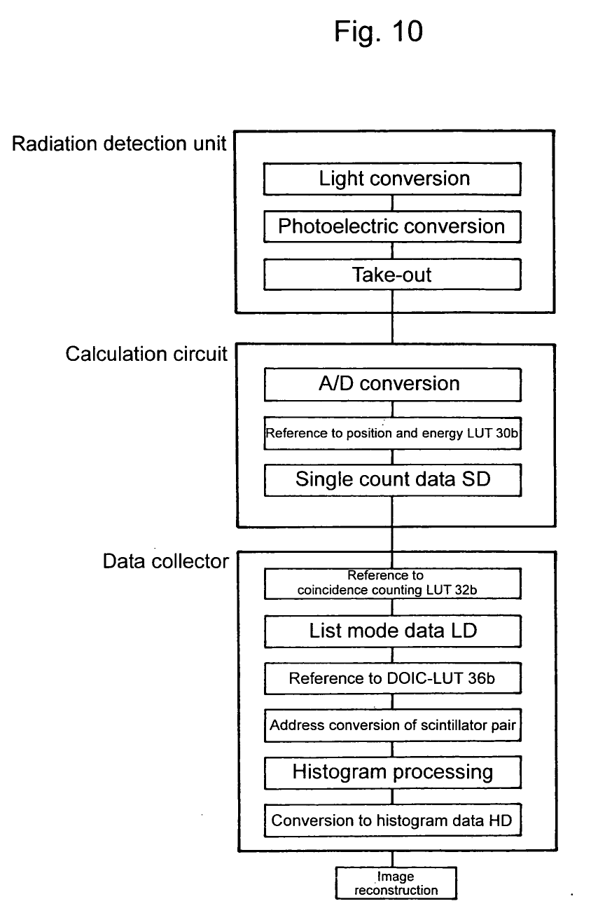

FIG. 9 shows a constitution of an example in which an error elimination method is performed in the PET scanner and FIG. 10 shows its procedures.

This PET scanner has 24 block-detectors arranged in the circumferential direction and 5 block-detector-rings arranged in the body axis direction, that is, 120 block detectors 20 in total.

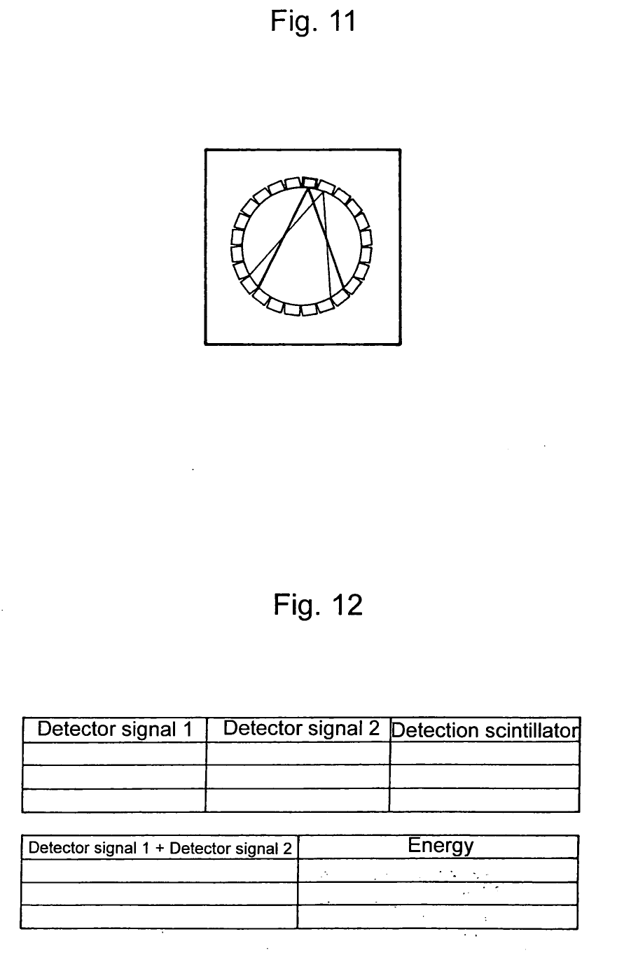

Each detector block is formed by 1024 scintillators (radiation detecting elements) arranged in 4 arrays of 16 rows and 16 columns. As shown in FIG. 11 as an example, when the annihilation radiation is detected in the detector 20, an analog signal (analog data AD) is output and converted into digital data in a calculation circuit 30a, and then converted into single count data SD serving as information on the position and energy of the radiation while referring to a position and energy lookup table (LUT) 30b retained in a memory in the circuit as shown in FIG. 12 as an example.

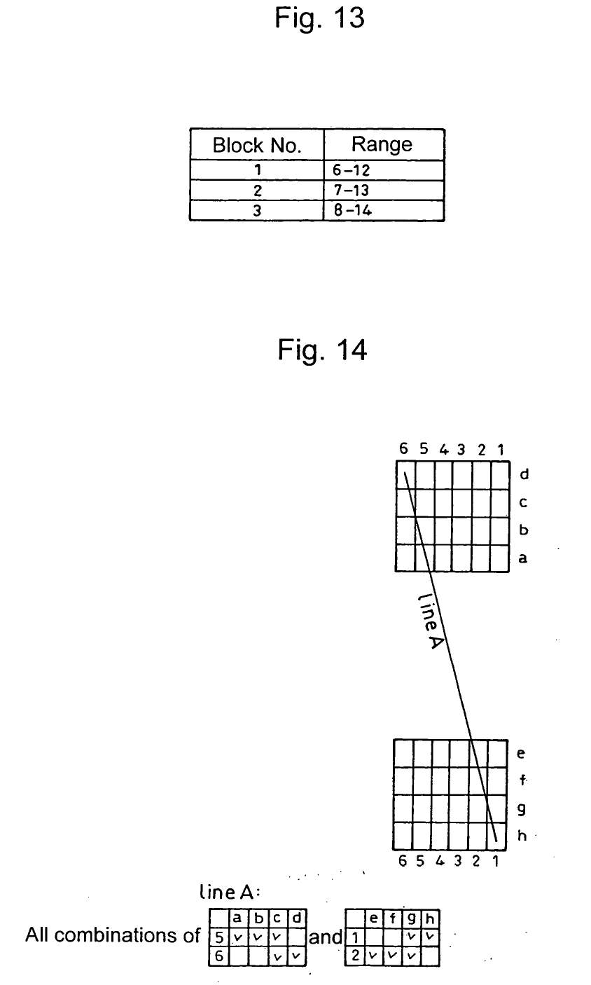

The single count data SD from each detector is sent to a coincidence count circuit 32a and converted into list mode data LD serving as address information of a scintillator pair showing a track of a pair of annihilation radiations. In the coincidence count circuit 32a, a coincidence counting LUT 32b shown in FIG. 13 as an example for defining a range of the block detector 20 searching the pair is retained in a memory in the circuit and the conversion is performed while referring to this.

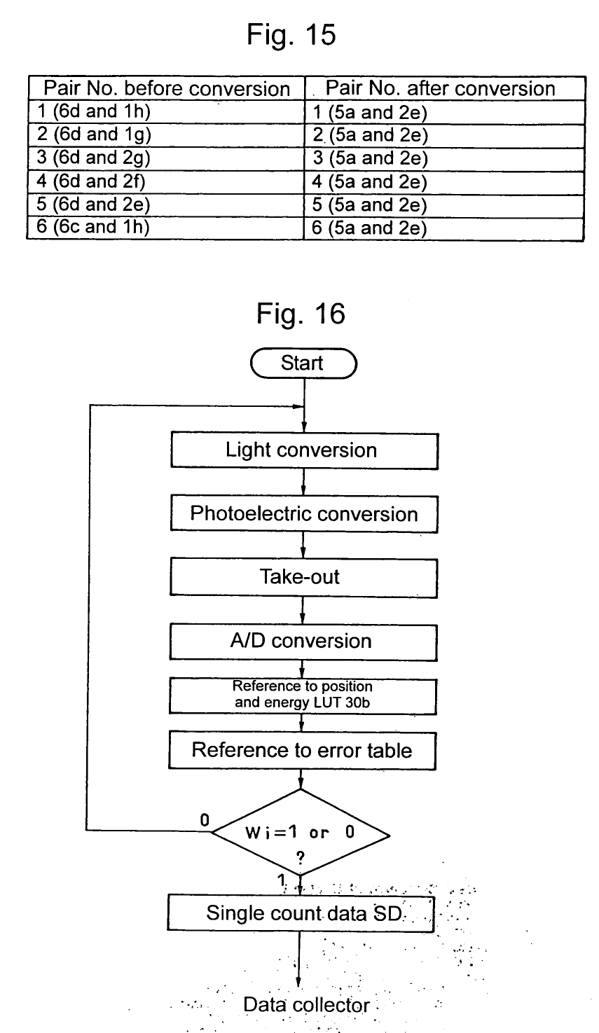

After converting the address of the scintillator pair in a DOIC converter 36a based on the DOI compression (DOIC) method for example, the list mode data LD is converted into histogram data HD in histogram processing 37. DOIC conversion is performed while referring to a DOIC-LUT 36b shown in FIG. 15 as an example for storing index information of the scintillator pair to be converted shown in FIG. 14 as an example. The image reconstruction calculation is performed based on this histogram data HD.

With regard to error specification, when the address information of the error detector is input from a screen of a console PC 44 for example, the corresponding error table 15 is created in the memory 38, and information is listed in the DOIC-LUT 36b so as to discard the list mode data LD related to the error detector. Specifically, the weight factor in the histogram processing 37 is set to be zero only for the error data. This processing corresponds to mounting of the data eliminator C in FIG. 8 which is to reduce the data quantity to be processed in the image reconstruction and also avoid the mixing between normal data and error data by the DOIC conversion 36a.

Amounting example of the data eliminator D in FIG. 8 corresponds to the point D in the drawing and can be realized by reading in the histogram data HD in the image reconstruction and then eliminating the corresponding error data before performing the image reconstruction calculation.

A mounting example of the data eliminators 42A and 42B in FIG. 8 can be realized by writing the information of the error detector to the position and energy LUT 30b or the coincidence counting LUT 32b at the points A and B in FIG. 9 so as to discard the error data at that time point. The procedures for processing in the data eliminator 42A are shown in FIG. 16.

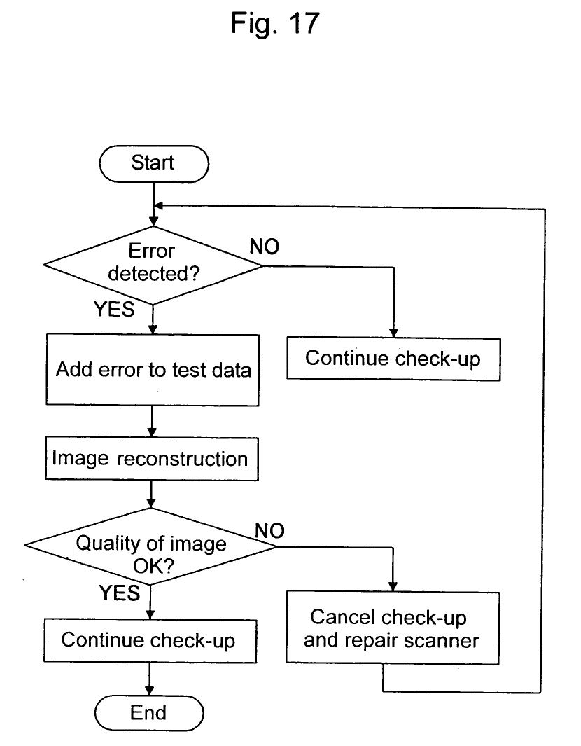

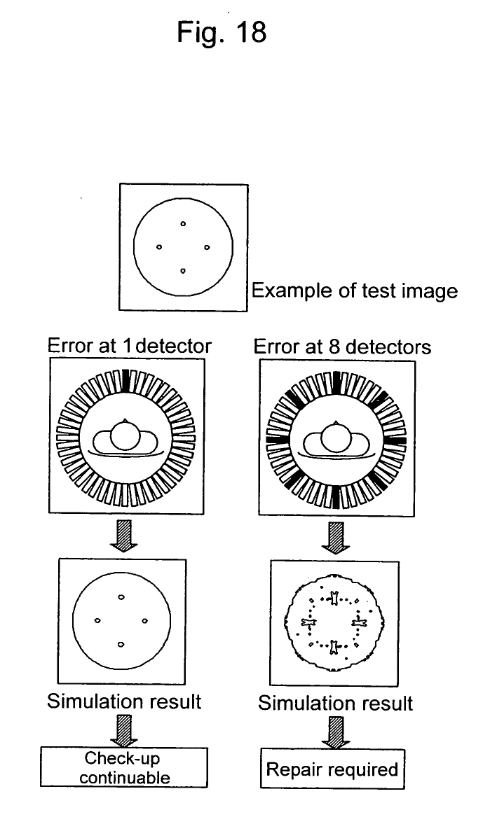

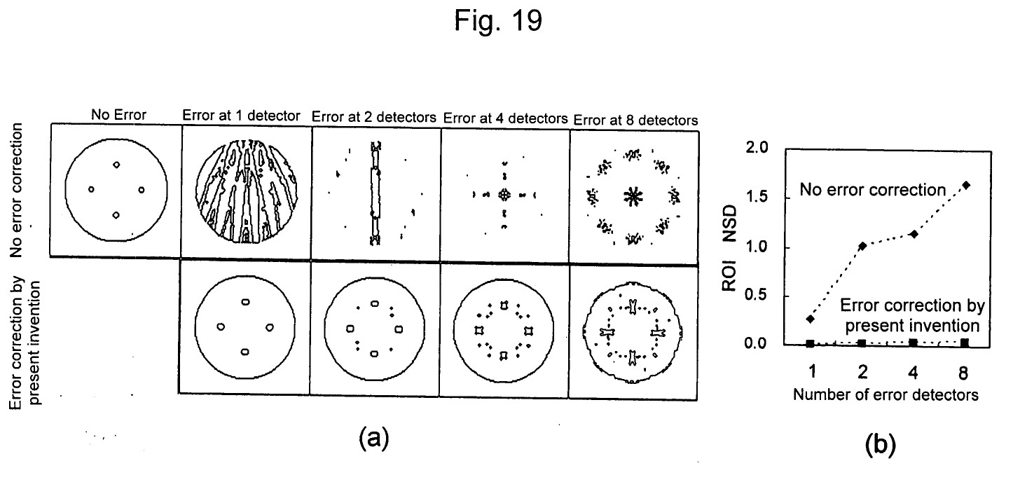

Reduction of the artifact in an image by correction of the system matrix does not always work for the detector error but there is a fear that the deteriorated quality of an image is caused by lack of information and a decrease in count. Its extent depends on location and the number of error detectors and the degree of the error. Thus, in a case where the detector error occurs, in order to determine whether or not a check-up is continuable, the error is simulatively caused in test data as shown in FIG. 18 as an example by procedures as shown in FIG. 17 and the image reconstruction is performed, thus making it possible to confirm the quality of an image as shown in FIG. 19(a) as an example. The vertical axis in FIG. 19(b) is a normalized standard deviation (NSD) of a region of interest (ROI).

In an example in FIG. 19, in a case of the error at one detector, there are a few artifacts in an image, thereby making the check-up continuable. Ina case of the error at eight detectors, the artifacts are largely found, thus making it possible to determine that the scanner is to be repaired.

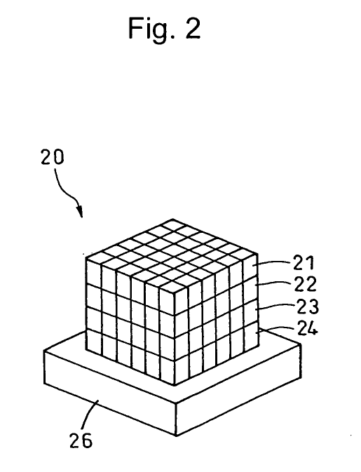

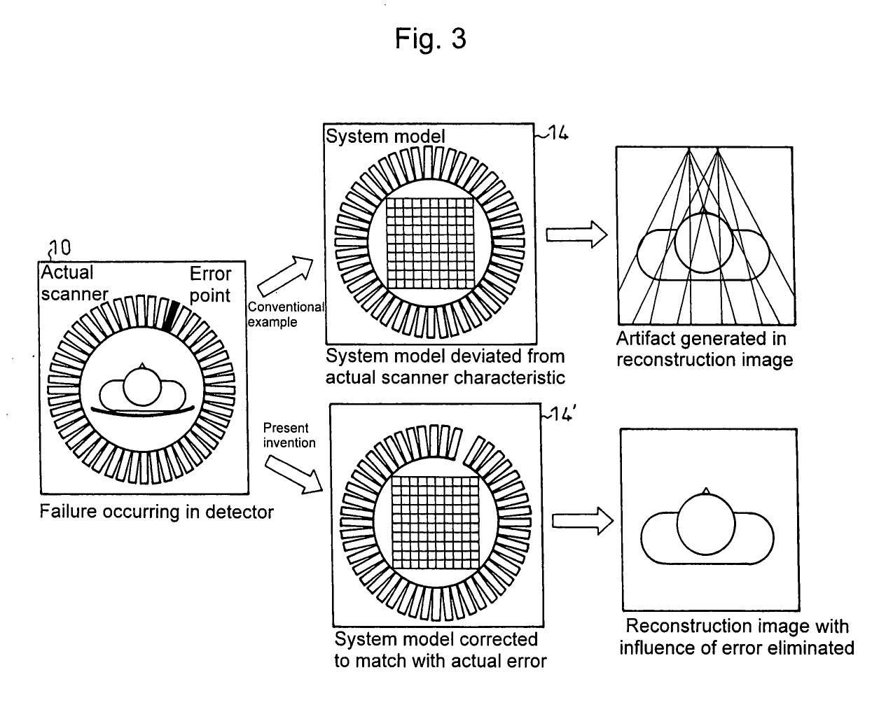

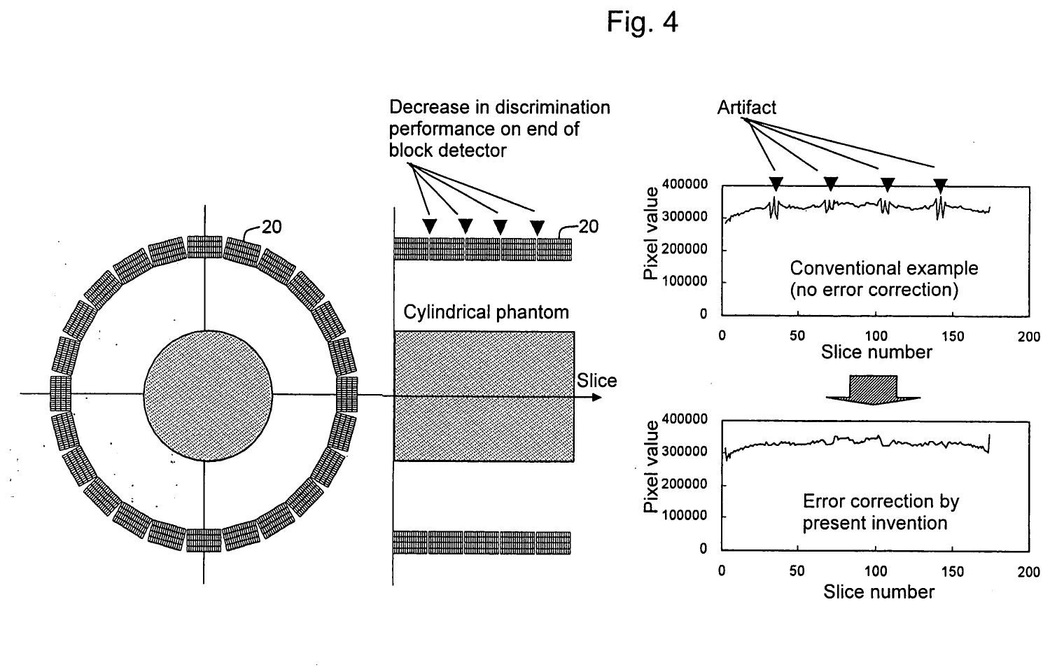

The block detector 20 shown in FIG. 2 has the capability of a low discrimination performance on block ends. The detector elements at the block ends are regarded as the error detectors for this capability of the detector, thus making it possible to increase the accuracy of the quality of an image as shown in the lower part of FIG. 4.

### Example 1

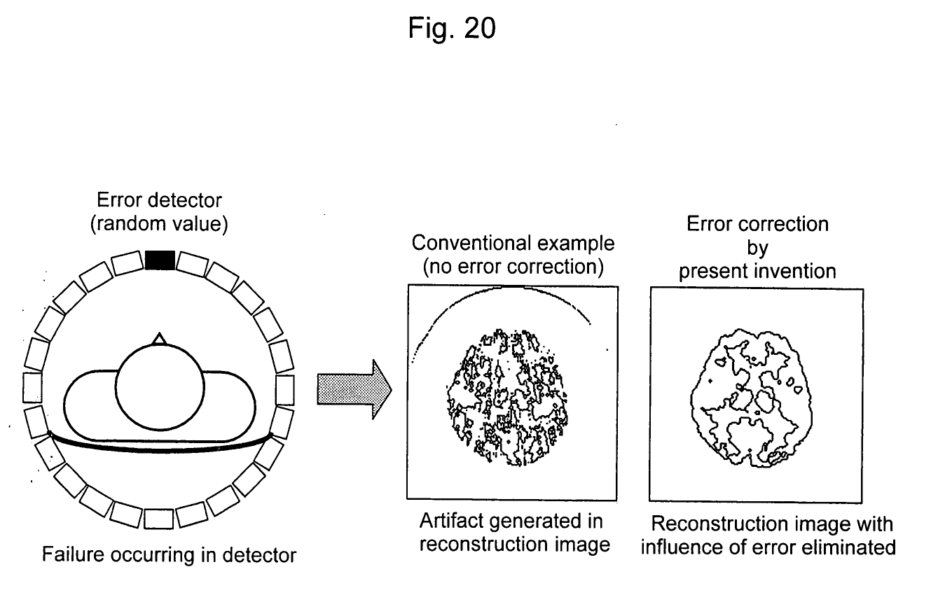

The present invention is mounted on a test machine of a PET scanner for the head to examine the effect thereof. Random values are given to one detector block in a center of the body axis as simulative errors in experimental data by a healthy volunteer, and then the reconstruction is performed by the three-dimensional iterative image reconstruction method. As shown in FIG. 20, strong artifacts generated in the reconstructed image due to the error of the detector is eliminated, and a favorable image can be obtained while eliminating the influence of the error by using the present invention.

### Example 2

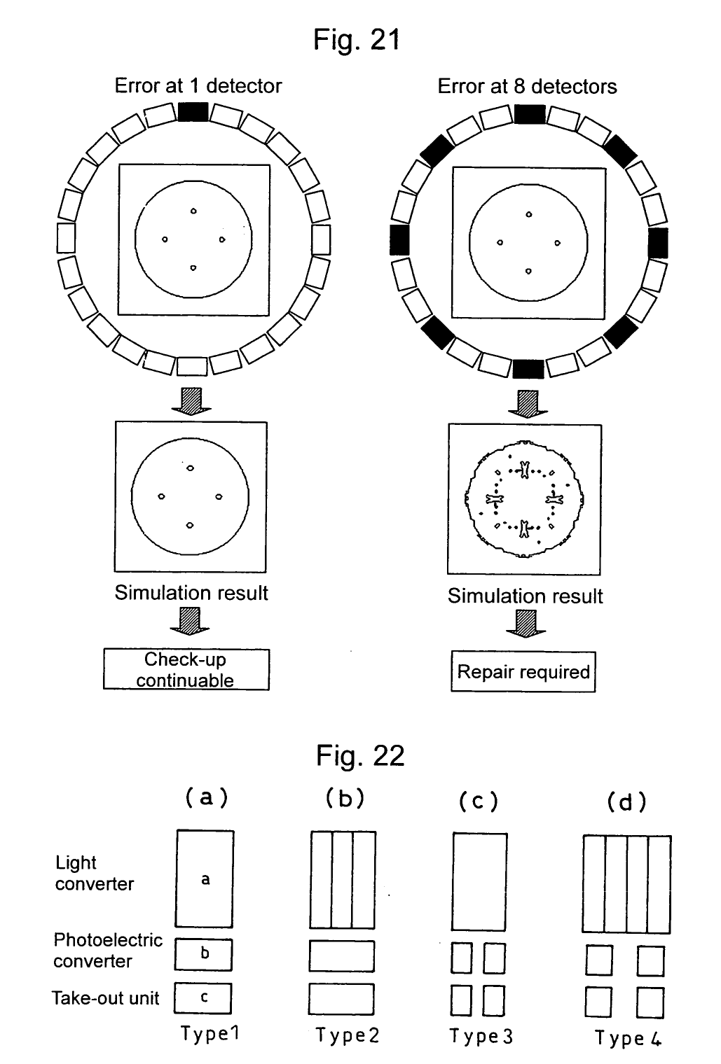

Assuming a case where the detector has failed, the influence on an image and a correction effect according to the present invention are examined. First, when an area for making an output of one and eight detector blocks zero is given to simulation data and then the two-dimensional image reconstruction is performed, a result as shown in FIG. 21 is obtained. In this example, although a spot is favorably imaged with the error at one detector, the quality of an image is insufficient with the error at eight detectors, thereby determining that the scanner is to be repaired.

### Example 3

With regard to the block detector having the capability of the low discrimination performance on the block ends, all the data bin corresponding to the detectors located at the crystal ring on the block end is considered as an error bin. That is, although the test machine of the PET scanner for the head has a structure of 16 crystal rings×5 blocks (a clearance between the blocks is for 2 crystals), this is regarded as 14 crystals×5 blocks (a clearance between the blocks is for 4 crystals). When the three-dimensional iterative image reconstruction method is applied to experimental measurement data of a cylindrical phantom (diameter of 20 cm and length of 26 cm), a result as shown in a lower part of FIG. 4 is obtained. By FIG. 4, it is clear that the crystal ring on the block end is eliminated, thereby suppressing the artifacts between the blocks (4 points).

Although the block detector as shown in FIG. 2 is used as the detector in the above description, a constitution of the detector is not limited to this but various constitutions as shown in FIG. 22 as an example may be adopted. FIG. 22(a) is an example in which a light converter (scintillator) a, a photoelectric converter (photo detection element) b and a take-out unit care connected individually as single units. FIG. 22(b) is an example in which the light converter a is plural units, and the photoelectric converter b and the take-out unit c are single units. FIG. 22(c) is an example in which the light converter a is a single unit, and the photoelectric converter b and the take-out unit c are plural units. FIG. 22(d) is an example in which the light converter a, the photoelectric converter b and the take-out unit c are all plural units. Alternatively, a semiconductor radiation detector may be used.

### INDUSTRIAL APPLICABILITY

The present invention can be used for a tomography scanner such as an X-ray CT scanner, a single photon emission computed tomography (SPECT) scanner, and a positron emission tomography (PET) scanner.

1. An image reconstruction method for a tomography scanner, wherein in a case where an error is included in measurement data relative to one or a plurality of detecting elements in the tomography scanner, a system matrix to be calculated or referenced on image reconstruction calculation is corrected in accordance with the error, thereby reducing an artifact generated in an image.

2. The image reconstruction method for the tomography scanner according to claim 1, wherein positional information of the detecting elements including the error and information on the degree of the error are stored in a storage device and referenced inside image reconstruction software, thereby correcting the system matrix in accordance with the error.

3. The image reconstruction method for the tomography scanner according to claim 1, wherein the measurement data corresponding to the detecting elements in which the error occurs is eliminated before performing the image reconstruction calculation.

4. The image reconstruction method for the tomography scanner according to claim 3, wherein in a detector unit, a coincidence count determiner, a data converter or a data addition unit, the measurement data corresponding to the detecting elements in which the error occurs is not output but eliminated.

5. A failure diagnosis method for a tomography scanner, wherein in a case where a failure or a trouble occurs at any point in the scanner, image reconstruction is performed to simulation data or other measurement data by applying the method according to claim 1 and quality of an image is confirmed, thereby simulating an influence of an error on the image reconstruction and determining whether the scanner is to be repaired or a check-up is continuable.

6. A tomography scanner, wherein in a case where an error is included in measurement data corresponding to one or a plurality of detecting elements in the tomography scanner, positional information of the detecting elements including the error and information on the degree of the error for correcting a system matrix to be calculated or referenced on image reconstruction calculation in accordance with the error are stored in a storage device.

7. A management program for a system matrix to be calculated or referenced on image reconstruction calculation, wherein in a case where an error is included in measurement data corresponding to one or a plurality of detecting elements in a tomography scanner, the system matrix is corrected in accordance with the error while referencing a storage device storing positional information of the detecting elements including the error and information on the degree of the error, thereby reducing an artifact generated in an image.

8. A failure diagnosis method for a tomography scanner, wherein in a case where a failure or a trouble occurs at any point in the scanner, image reconstruction is performed to simulation data or other measurement data by applying the method according to claim 2 and quality of an image is confirmed, thereby simulating an influence of an error on the image reconstruction and determining whether the scanner is to be repaired or a check-up is continuable.

9. A failure diagnosis method for a tomography scanner, wherein in a case where a failure or a trouble occurs at any point in the scanner, image reconstruction is performed to simulation data or other measurement data by applying the method according to claim 3 and quality of an image is confirmed, thereby simulating an influence of an error on the image reconstruction and determining whether the scanner is to be repaired or a check-up is continuable.
